(19) United States
(12) Patent Application Publication
(10) Pub. No.: US 2024/0389504 A1
(43) Pub. Date: Nov. 28, 2024

(54) DETACHABLY FASTENABLE TRIMMER HEAD

(71) Applicant: Shakespeare Company, LLC, Greer, SC (US)

(72) Inventors: David Benson Skinner, Columbia, SC (US); Jonathan D. O'Neal, Irmo, SC (US)

(21) Appl. No.: 18/644,719

(22) Filed: Apr. 24, 2024

Related U.S. Application Data
(60) Provisional application No. 63/503,634, filed on May 22, 2023.

(51) Int. Cl. A01D 34/73; A01D 34/416; A01D 34/68; A01D 101/00

(52) U.S. Cl. CPC A01D 34/733; A01D 34/4163; A01D 34/4165; A01D 34/6806; A01D 2101/00

(57) ABSTRACT

A rotary apparatus is provided for attachment to a rotating shaft. The rotary apparatus includes a mounting base and an attachment. The mounting base includes a circular plate, a receptacle centrally located at the circular plate and being configured to receive the rotating shaft, and a mounting base circumferential side wall connected to the circular plate. The circumferential side wall includes a first aperture and a second aperture. The attachment includes an attachment circumferential side wall having a first resilient retaining clip and a second resilient retaining clip. The first resilient retaining clip is configured to releasably lock into the first aperture, and the second resilient retaining clip is configured to releasably lock into the second aperture so as to releasably fasten the attachment to the mounting base.

This applications claims priority to and the benefit of U.S. provisional application No. 63/503,634, filed May 22, 2023, which is hereby incorporated by reference herein in its entirety.

### FIELD

### Field

This disclosure relates generally to trimmer heads and more particularly to detachably fastenable trimmer heads.

### Background

A trimmer, also known as a weed wacker, string trimmer, and/or weed eater, is a tool used for cutting grass, weeds, or other foliage in areas that are difficult to reach with a lawn mower.

FIG. 1 illustrates a conventional trimmer 100. The trimmer 100 may include a motor 102, a shaft 104, a cutting head 106, a guard 108, a handle 110, and a trigger 112. The motor 102 is the power source that drives the cutting mechanism. The motor 102 can be powered by gasoline or electricity depending on the type of trimmer. The shaft 104 connects the motor 102 to the cutting head 106 and can be straight or curved depending on the model. In some instances, the shaft 104 is usually made of aluminum or steel for durability. The motor provides a rotating motion, which is transferred to the shaft 104.

As indicated by the name, the cutting head 106 does the cutting. The cutting head 106 typically uses a flexible monofilament line 114 made of nylon, which spins at high speed to cut through grass and weeds. Other types of more ridged cutting lines or blades may be used. The guard 108 is a safety feature that prevents debris from flying up and hitting the user. The guard is usually made of plastic and is located between the cutting head 106 and the handle 110. The handle 110 is where the user grips the trimmer 100. It can be ergonomically designed for comfortable use, and some models have adjustable handles for different user heights. The trigger 112 is located on the handle 110 and controls the speed of the cutting head 106. Squeezing the trigger 112 will increase the speed of the cutting head 106, while releasing the trigger 112 will slow the cutting head 106 down or stop the cutting head 106 entirely.

Trimmer 100 is a “bump head” trimmer. A bump head attachment on a trimmer is a mechanism that allows the user to quickly and easily dispense more trimming line as it wears down during use. The bump head typically includes a spool of trimming line, which is wound around a spool inside the head. As the line wears down during use, the user can “bump” the head against the ground to release more line from the spool. This allows the user to continue trimming without having to stop and manually adjust the length of the line.

Many conventional trimmers have replaceable heads that allow for the use of different cutting devices. Some common cutting heads include a string trimmer head, a brush cutter blade, a hedge trimmer attachment, and an edger attachment. FIG. 2 illustrates an example brush cutter blade head 200 that includes a metal brush cutter blade 202. FIG. 3 illustrates a brush cutter blade head 300 that includes a nylon brush cutter tri-blade 302. The brush cutter blade is a heavier-duty cutting head that uses a metal blade to cut through thick vegetation, brush, and saplings. The hedge trimmer attachment is an attachment that allows the trimmer to be used as a hedge trimmer. The hedge trimmer attachment typically has a longer cutting blade with teeth to cut through branches and leaves. The edger attachment is an attachment that allows the trimmer to be used as an edger to trim along the edges of sidewalks, driveways, and other hard surfaces. The cultivator attachment is an attachment that allows the trimmer to be used as a cultivator to loosen and turn soil in garden beds.

What is needed is a trimmer system that enables easy attachment and removal of trimmer attachments.

### BRIEF DESCRIPTION OF THE DRAWINGS

The detailed description is set forth with reference to the accompanying drawings. In some instances, the use of the same reference numerals may indicate similar or identical items. Various embodiments may utilize elements and/or components other than those illustrated in the drawings, and some elements and/or components may not be present in various embodiments. Throughout this disclosure, depending on the context, singular and plural terminology may be used interchangeably.

FIG. 1 illustrates a prior art trimmer.

FIG. 2 illustrates a prior art trimmer having a steel circular saw blade attached.

FIG. 3 illustrates a prior art trimmer having a nylon tri-blade attached.

FIG. 4 illustrates a trimmer in accordance with one or more embodiments of the present disclosure.

FIG. 5 illustrates a magnified view of a portion of the trimmer of FIG. 4.

FIG. 6A illustrates a portion of the mounting base and the attachment of the trimmer of FIG. 4 as separated at a time to.

FIG. 6B illustrates the portion of the mounting base and the attachment of the trimmer of FIG. 4 as separated at a time t1.

FIG. 6C illustrates the portion of the mounting base and the attachment of the trimmer of FIG. 4 during attachment at a time t2.

FIG. 6D illustrates the portion of the mounting base and the attachment of the trimmer of FIG. 4 as attached at a time t3.

FIG. 7A illustrates the portion of the mounting base and the attachment of the trimmer of FIG. 4 when detachment is initiated a time t4.

FIG. 7B illustrates the portion of the mounting base and the attachment of the trimmer of FIG. 4 during detachment at a time t5.

FIG. 7C illustrates the portion of the mounting base and the attachment of the trimmer of FIG. 4 as detached at a time to.

FIG. 8 illustrates an example mounting base in accordance with one or more embodiments of the present disclosure.

FIG. 9 illustrates an example attachment in accordance with one or more embodiments of the present disclosure.

FIG. 10 illustrates another example attachment in accordance with one or more embodiments of the present disclosure.

FIG. 11 illustrates another example attachment in accordance with one or more embodiments of the present disclosure.

### DETAILED DESCRIPTION

A trimmer system in accordance with one or more embodiments of the present disclosure enables easy attachment and removal of trimmer attachments, in some instances without the need of removing bolts and washers. In this manner, this disclosure relates generally to a trimmer system wherein multiple attachments may be detachable fastened to a mounting base, in some instances without the need for bolts and washers.

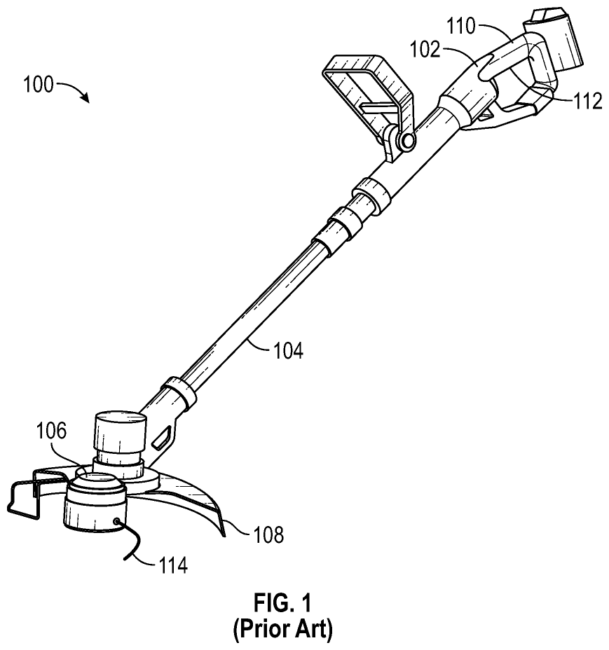

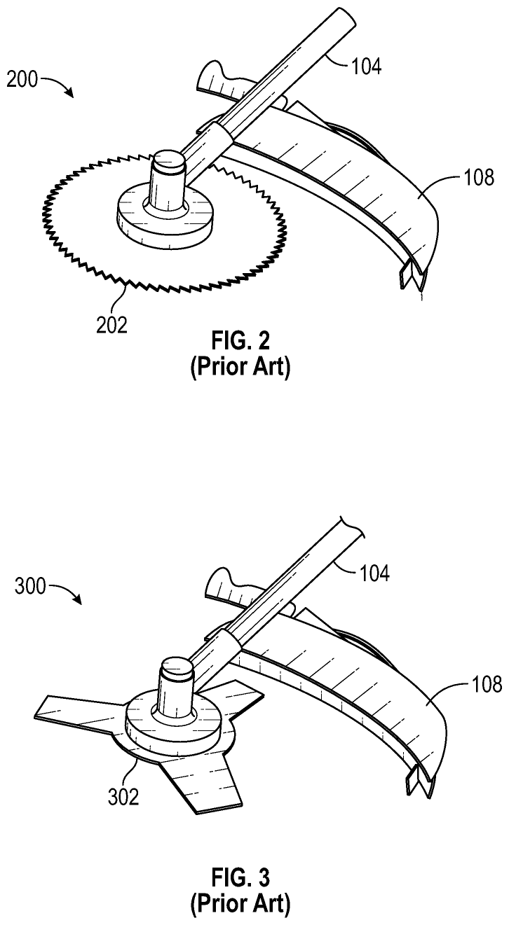

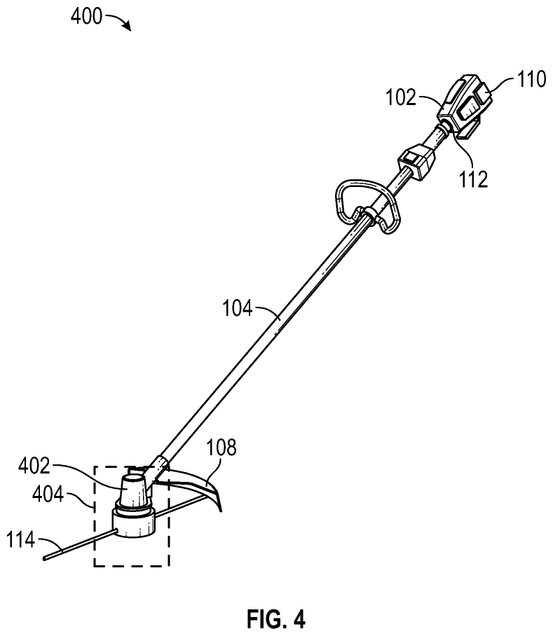

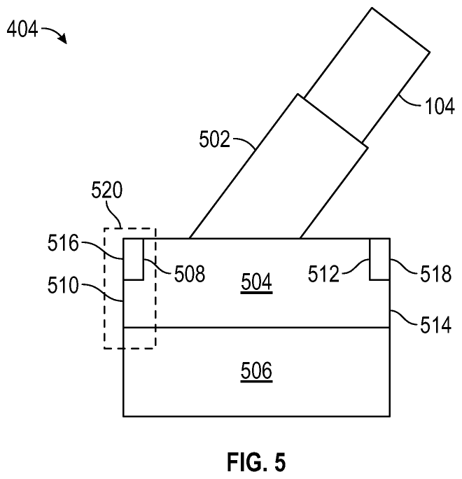

Turning now to the drawings, FIG. 4 illustrates a trimmer 400 in accordance with one or more embodiments of the present disclosure. The trimmer 400 includes the motor 102, the shaft 104, a cutting head 402, the guard 108, the handle 110, and the trigger 112. The cutting head 404 includes the flexible monofilament line 114 made of nylon, which spins at high speed to cut through grass and weeds. The trimmer 400 differs from the trimmer 100 discussed above with reference to FIG. 1, in that the trimmer 400 includes a mounting base and an attachment. This will be described in greater detail with reference to FIGS. 5-11.

FIG. 5 illustrates a magnified view of a portion 404 of the trimmer 400 of FIG. 4. As shown in FIG. 5, the trimmer 400 includes an angled connector 502, a mounting base 504, and an attachment 506. The angled connector 502 may be any device or system that is configured to transfer the rotating motion of the rotating of shaft 104 to a rotation of mounting base 504. A non-limiting example of the angled connector 503 includes a combination of bevel gears. Bevel gears have angled teeth that allow them to mesh with another bevel gear at an angle. When one bevel gear turns, it transfers its rotational motion to the other bevel gear, which turns in a different plane or axis. Bevel gears can have different configurations depending on the angle of the teeth and the size and shape of the gears. They are commonly used in machinery and mechanical devices where power needs to be transferred between two axes that are not in line with each other.

The mounting base 504 is configured to be mounted to the shaft 104. The attachment 506 is configured to be releasably fastened to the mounting base 504. In particular, the mounting base 504 includes an aperture 508 on its outer circumferential side wall and an aperture 512 on its outer circumferential side wall. The aperture 508 is configured to provide a shortened side wall portion 510, whereas the aperture 512 is configured to provide a shortened side wall portion 510. The mounting base 506 includes a resilient retaining clip 516 configured to releasably lock into the aperture 508 and includes a resilient retaining clip 518 configured to releasably lock into the aperture 512 so as to releasably fasten the attachment 506 to the mounting base 504. In this manner, the attachment 506 may be attached to the mounting base 504 by way of a “quick release” system.

In operation, the motor 102 provides a rotating motion to the shaft 104. The rotation of the shaft 104 therefore results in a rotation of the mounting based 504 combined with the attachment 506.

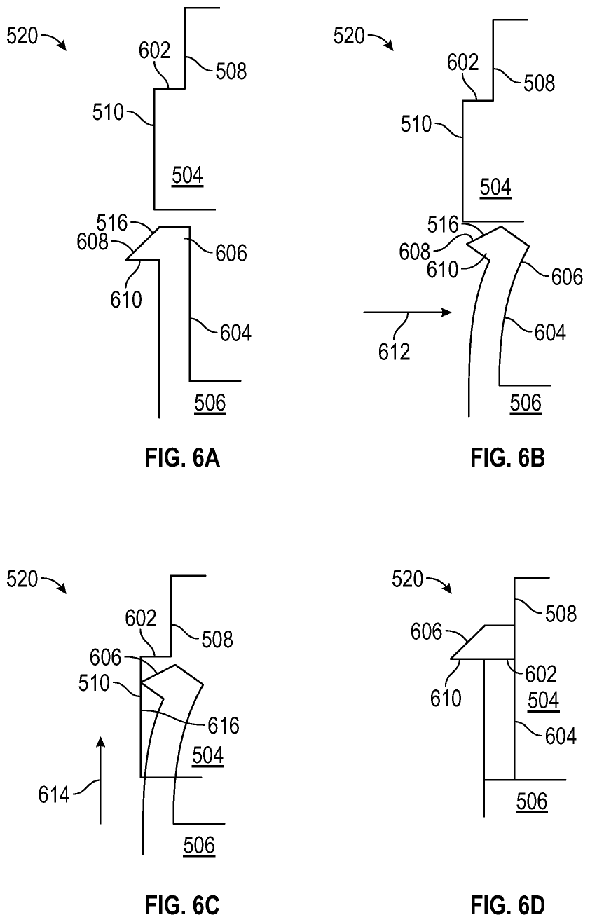

FIG. 6A illustrates a portion 520 of the mounting base 504 and the attachment 506 of the trimmer 400 of FIG. 4 as separated at a time to. As shown in FIG. 6A, the aperture 508 includes an engaging lip 602 that is perpendicular to the shortened side wall portion 510. The resilient retaining clip 516 of the attachment 506 includes a straight arm portion 604, and a head portion 606. The head portion 606 includes a slanted face 608 and a resting lip 610.

FIG. 6B illustrates the portion 510 of the mounting base 504 and the attachment 506 of the trimmer 400 of FIG. 4 as separated at a time t1. The resilient retaining clip 516 is configured to be deflected in a direction indicated by the arrow 612, for example by pressing of a user's fingers. As such, when deflected, the slanted face 608 is configured to deflect beyond the shortened side wall portion 510 of the mounting base 504.

FIG. 6C illustrates the portion 510 of the mounting base 504 and the attachment 506 of the trimmer 400 of FIG. 4 during attachment at a time t2. While the slanted face 608 is deflected beyond the shortened side wall portion 510 of the mounting base 504, the attachment 506 may be pushed into the mounting base 504 as shown by the arrow 614, for example by a user. In this state, the head portion 606 of the attachment 506 may slide along an inside surface 616 of the mounting base 504.

FIG. 6D illustrates the portion 510 of the mounting base 504 and the attachment 506 of the trimmer 400 of FIG. 4 as attached at a time t3. When the attachment 506 is pushed sufficiently into the mounting base 504, the head portion 606 will emerge from the aperture 508, the straight arm portion 604 will “snap” back place, and the resting lip 610 of the resilient retaining clip 516 of the attachment 506 will rest on the engaging lip 602 of the mounting base 504, thus locking the resilient retaining clip 516 into the aperture 508.

Returning to FIG. 5, the resilient retaining clip 518 may be similarly locked into the aperture 512.

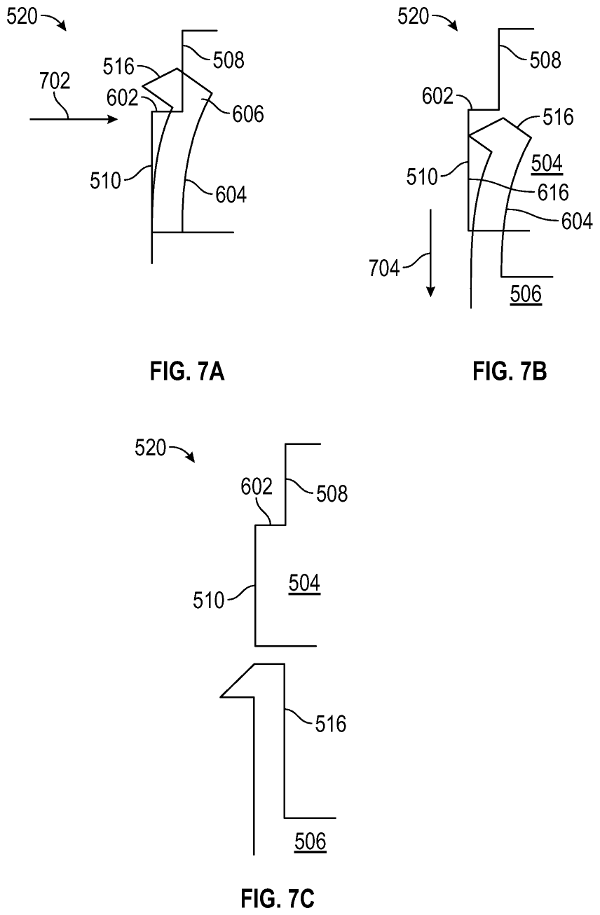

It should be noted, that in accordance with one or more embodiments of the present disclosure, the attachment 506 may be easily detached from the mounting base 504. As such, in accordance with one or more embodiments of the present disclosure, the attachment 506 may be detachably fastened to the mounting based 504. The detachment of the attachment 506 from the mounting base 504 will now be described in greater detail with reference to FIGS. 7A-C.

FIG. 7A illustrates the portion 510 of the mounting base 504 and the attachment 506 of the trimmer 400 of FIG. 4 when detachment is initiated a time t4. As shown in FIG. 7A, the resilient retaining clip 516 is configured to be deflected in a direction indicated by the arrow 702, for example by pressing of a user's fingers. In this state, the head portion 606 of the resilient retaining clip 516 may disengage with the engaging lip 602 of the mounting base 504.

FIG. 7B illustrates the portion 510 of the mounting base 504 and the attachment 506 of the trimmer 400 of FIG. 4 during detachment at a time t5. In this state, the user may pull the attachment 506 in a direction indicated by the arrow 704 away from the mounting base 504. In this manner, in this state, the head portion 606 of the attachment 506 may slide along the inside surface 616 of the mounting base 504.

FIG. 7C illustrates the portion 510 of the mounting base 504 and the attachment 506 of the trimmer 400 of FIG. 4 as detached at a time to. In this state, the attachment 506 is removed from the mounting base 504. At this point in time, another, different type of attachment may be detachably fastened to the mounting base 504 in accordance with one or more embodiments of the present disclosure.

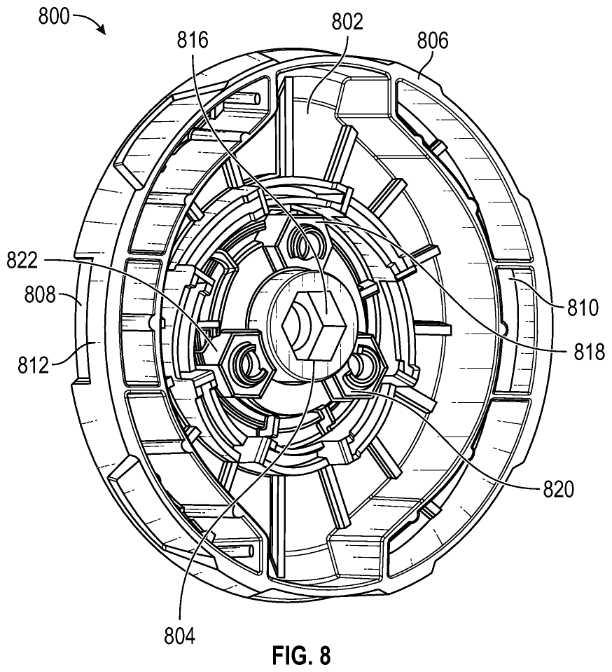

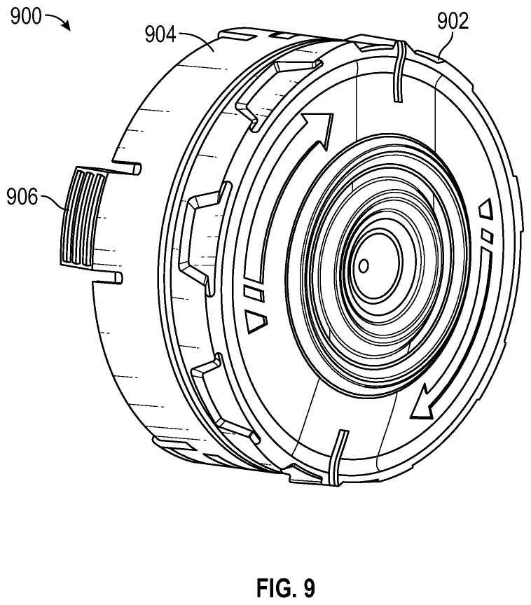

FIG. 8 illustrates an example mounting base 800 in accordance with one or more embodiments of the present disclosure. The mounting base 800 may be similar to the mounting base 504. In some instances, the mounting base 800 includes a circular plate 802, a receptacle 804 that is centrally located at the circular plate 802, and a circumferential side wall 806. The circumferential side wall 806 includes an aperture 808 and an aperture 810. In this non-limiting embodiment, the aperture 808 is disposed 180° opposite to the aperture 810. That is, the aperture 808 may be diametrically opposed to the aperture 810. The aperture 808 is configured so as to create a shortened side wall portion 812 in the circumferential side wall 806. Similarly, the aperture 810 is configured so as to create a shortened side wall portion 814 in the circumferential side wall 806. The aperture 808 and the aperture 810 enable an attachment to detachably attach to the mounting base 800 in a manner similar to that discussed above with reference to FIGS. 6A-7C.

In certain embodiments, the receptable 804 is configured to attach to the angled connector 502. In this manner, the mounting base 800, when attached to the angled connector 502, will rotate with the angled connector 502, which will rotate with the shaft 104, which will rotate from the rotating motion provided by the motor 102. The mounting base 800 additionally includes a female receptacle 816, centrally located at receptacle 804, that is configured to receive a male insert of an attachment. The connection of a male insert of an attachment to the female receptable 816 enables the attached attachment to rotate with the mounting base 800 when the mounting base 800 rotates with the shaft 104.

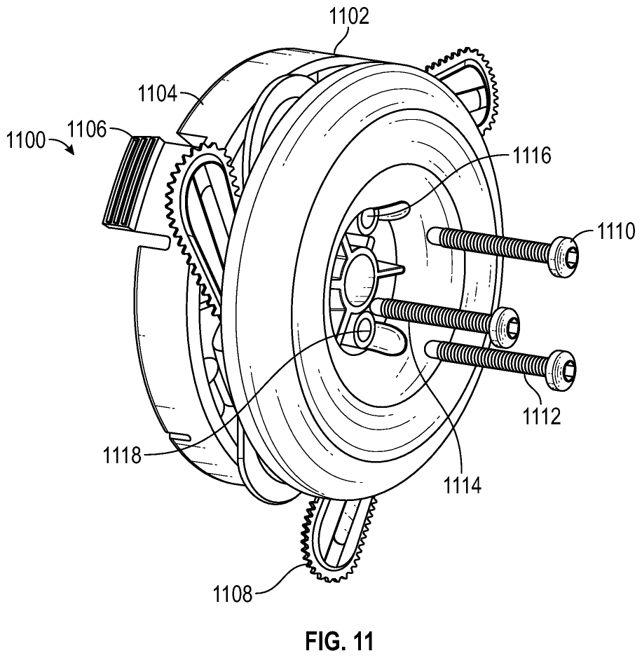

In some embodiments, an attachment might have a mass that is particularly high. In such cases, the attachment of the mounting base 800 to the mounting base 504 solely on the interaction of the retaining clip 516 and the retaining clip 518, with respective shortened sidewall portion 510 and shortened sidewall portion 514, might not be sufficient. As such, an optional bolster to the attachment may include supplement attachment bolts. For example, as shown in FIG. 8, the mounting base 800 may optionally include a threaded receiving hole 818 configured to receive a threaded bolt, a threaded receiving hole 820 configured to receive a threaded bolt, and a threaded receiving hole 822 configured to receive a threaded bolt, which will be discussed below with reference to FIG. 11.

FIG. 9 illustrates an example attachment 900 in accordance with one or more embodiments of the present disclosure. The attachment 900 includes a bump head body portion 902, a circumferential side wall 904, a resilient retaining clip 906, and another resilient retaining clip that is circumferentially opposite to the resilient retaining clip 906. The bump head body portion 902 may be any known conventional bump head that includes trimming line and is configured to release a portion of the trimming line. The resilient retaining clip 906 is configured to operate in a manner similar to that of the resilient retaining clip 516 as discussed above with reference to FIGS. 6A-7C. Accordingly, the attachment 900 may be detachably fastened to the mounting base 800 of FIG. 8 in a manner as discussed above with reference to FIGS. 6A-7C.

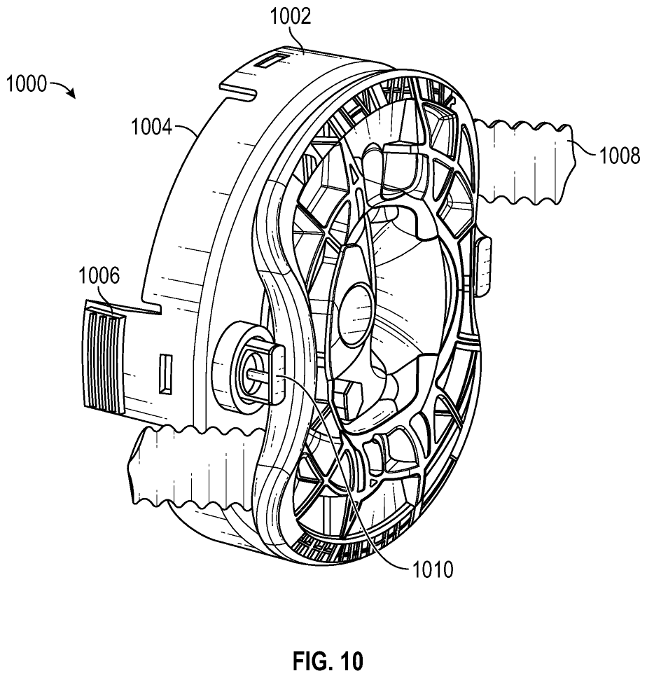

FIG. 10 illustrates another example attachment 1000 in accordance with one or more embodiments of the present disclosure. The attachment 1000 includes a nylon blade body portion 1002, a circumferential side wall 1004, a resilient retaining clip 1006, and another resilient retaining clip that is circumferentially opposite to the resilient retaining clip 1006. The nylon blade body portion 1002 may be any known conventional nylon blade head that includes a plurality of nylon blades, a sample of which is indicated as nylon blade 1008. Although described as nylon, the blades 1008 may be any suitable material. The resilient retaining clip 1006 is configured to operate in a manner similar to that of the resilient retaining clip 516 as discussed above with reference to FIGS. 6A-7C. Accordingly, the attachment 1000 may be detachably fastened to the mounting base 800 of FIG. 8 in a manner as discussed above with reference to FIGS. 6A-7C. In some instances, the attachment 1000 may include one or more pivoting posts 1010, and trimmer line may be disposed through an aperture in each of the pivoting posts 1010. In this manner, the attachment 1000 may be configured to accept fixed trimmer line lengths. As a result, the attachment 1000 comprises two cutting methods, the blades 10008 and/or trimmer line attached to the pivoting posts 1010.

FIG. 11 illustrates another example attachment 1100 in accordance with one or more embodiments of the present disclosure. The attachment 1100 includes a blade body portion 1102, a circumferential side wall 1104, a resilient retaining clip 1106, and another resilient retaining clip that is circumferentially opposite to the resilient retaining clip 1106. The blade body portion 1102 may be any known conventional blade head that includes a plurality of metal blades (or other more robust blades), a sample of which is indicated as metal blade 1108. The resilient retaining clip 1106 is configured to operate in a manner similar to that of the resilient retaining clip 516 as discussed above with reference to FIGS. 6A-7C. Accordingly, the attachment 1100 may be detachably fastened to the mounting base 800 of FIG. 8 in a manner as discussed above with reference to FIGS. 6A-7C.

Further, in one or more embodiments in accordance with aspects of the present disclosure, because the metal blades of the blade head has much more mass, additional attachment support may be included. For example, retaining bolts 1110, 1112, and 1114 may be inserted through the blade body portion 1102 and into the mounting base 800. In particular, the retaining bolt 1110 may insert through a bolt hole 1116 of the blade body portion 1102, the retaining bolt 1112 may insert through a bolt hole 1118 of the blade body portion 1102, and the retaining bolt 1114 may insert through a bolt hole of the blade body portion 1102. With additional reference to FIG. 8, the retaining bolt 1110 may screw into the threaded receiving hole 818, the retaining bolt 1112 may screw into the threaded receiving hole 820, and the retaining bolt 1114 may screw into the threaded receiving hole 822. In this manner, the retaining bolts 1110, 1112, and 1114 provide supplemental attachment for attaching the attachment 1110 to the mounting base 800, which might be required for the additional mass of the metal blades of the attachment 1110.

With a conventional trimmer, different functional heads may be attached/detached at needed. However, the attachment/detachment of such functional heads include the convoluted and cumbersome process of removing a plurality of bolts and nuts. With a trimmer in accordance with one or more embodiments of the present disclosure, a single mounting base may be in communication with a rotating shaft, whereas any one of a plurality of attachments may be removably fastened to the mounting base via the pressing of resilient retaining clips. In this manner, the cumbersome burden of unscrewing bolts is not required, in some instances, to replace a functional attachment.

Although specific embodiments of the disclosure have been described, numerous other modifications and alternative embodiments are within the scope of the disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A rotary apparatus for attachment to a rotating shaft, the rotary apparatus comprising:
a mounting base; and
an attachment,
wherein the mounting base includes a circular plate, a receptacle centrally located at the circular plate, and a mounting base circumferential side wall connected to the circular plate,
wherein the mounting base circumferential side wall includes a first aperture and a second aperture,
wherein the attachment includes an attachment circumferential side wall having a first resilient retaining clip and a second resilient retaining clip,
wherein the first resilient retaining clip is configured to releasably lock into the first aperture, and the second resilient retaining clip is configured to releasably lock into the second aperture so as to releasably fasten the attachment to the mounting base.

2. The rotary apparatus of claim 1, wherein the attachment includes a bump head attachment having trimming line and being configured to release a portion of the trimming line.

3. The rotary apparatus of claim 1, wherein the attachment includes a blade attachment.

4. The rotary apparatus of claim 3, wherein the blade attachment comprises a non-metal material.

5. The rotary apparatus of claim 3, wherein the blade attachment comprises metal.

6. The rotary apparatus of claim 5,
wherein the mounting base further includes a threaded receiving hole,
wherein the attachment includes a bolt hole and a bolt disposed in the bolt hole, and
wherein the attachment is configured to releasably fasten to the mounting base such that the bolt can screw into the threaded receiving hole.

7. The rotary apparatus of claim 6,
wherein the mounting base further includes a second threaded receiving hole and a third threaded receiving hole,
wherein the threaded receiving hole is disposed adjacent to the receptacle,
wherein the second threaded receiving hole is disposed adjacent to the receptacle,
wherein the third threaded receiving hole is disposed adjacent to the receptacle,
wherein the threaded receiving hole, the second threaded receiving hole, and the third threaded receiving hole are equally radially disposed,
wherein the threaded receiving hole is circumferentially separated from the second threaded receiving hole by 120° and is circumferentially separated from the third threaded receiving hole by 120°, and
wherein the second threaded receiving hole is additionally circumferentially separated from the third threaded receiving hole by 120°.

8. An apparatus comprising:
a motor configured to provide a rotating motion;
a rotating shaft configured to rotate from the rotating motion provided by the motor;
a mounting base configured to be mounted to the rotating shaft; and
an attachment,
wherein the mounting base includes a circular plate, a receptacle centrally located at the circular plate and being configured to receive the rotating shaft, and a mounting base circumferential side wall connected to the circular plate,
wherein the mounting base circumferential side wall includes a first aperture and a second aperture,
wherein the attachment includes an attachment circumferential side wall having a first resilient retaining clip and a second resilient retaining clip,
wherein the first resilient retaining clip is configured to releasably lock into the first aperture, and the second resilient retaining clip is configured to releasably lock into the second aperture so as to releasably fasten the attachment to the mounting base.

9. The apparatus of claim 8, wherein the attachment includes a bump head attachment having trimming line and being configured to release a portion of the trimming line.

10. The apparatus of claim 8, wherein the attachment includes a blade attachment.

11. The apparatus of claim 10, wherein the blade attachment comprises a non-metal material.

12. The apparatus of claim 10, wherein the blade attachment comprises metal.

13. The apparatus of claim 12,
wherein the mounting base further includes a threaded receiving hole,
wherein the attachment includes a bolt hole and a bolt disposed in the bolt hole, and
wherein the attachment is configured to releasably fasten to the mounting base such that the bolt can screw into the threaded receiving hole.

14. The apparatus of claim 13,
wherein the mounting base further includes a second threaded receiving hole and a third threaded receiving hole,
wherein the threaded receiving hole is disposed adjacent to the receptacle,
wherein the second threaded receiving hole is disposed adjacent to the receptacle,
wherein the third threaded receiving hole is disposed adjacent to the receptacle,
wherein the threaded receiving hole, the second threaded receiving hole and the third threaded receiving hole are equally radially disposed,
wherein the threaded receiving hole is circumferentially separated from the second threaded receiving hole by 120° and is circumferentially separated from the third threaded receiving hole by 120°, and
wherein the second threaded receiving hole is additionally circumferentially separated from the third threaded receiving hole by 120°.

15. An apparatus comprising:
a motor configured to provide a rotating motion;
a rotating shaft configured to rotate from the rotating motion provided by the motor;
a mounting base configured to be mounted to the rotating shaft; and
an attachment,
wherein the mounting base includes a circular plate, a receptacle centrally located at the circular plate and being configured to receive the rotating shaft, and a mounting base circumferential side wall connected to the circular plate,
wherein the mounting base circumferential side wall includes a first aperture and a second aperture,
wherein the attachment includes an attachment circumferential side wall having a first resilient retaining clip and a second resilient retaining clip,
wherein the first resilient retaining clip is configured to releasably lock into the first aperture, and the second resilient retaining clip is configured to releasably lock into the second aperture so as to releasably fasten the attachment to the mounting base.

16. The apparatus of claim 15, wherein the attachment includes a bump head attachment having trimming line and being configured to release a portion of the trimming line.

17. The apparatus of claim 15, wherein the attachment includes a blade attachment.

18. The apparatus of claim 17, wherein the blade attachment comprises a non-metal material.

19. The apparatus of claim 17, wherein the blade attachment comprises metal.

20. The apparatus of claim 19,
wherein the mounting base further includes a threaded receiving hole,
wherein the attachment includes a bolt hole and a bolt disposed in the bolt hole, and
wherein the attachment is configured to releasably fasten to the mounting base such that the bolt can screw into the threaded receiving hole.
